(19) United States
(12) Patent Application Publication
(10) Pub. No.: US 2004/0052980 A1
(43) Pub. Date: Mar. 18, 2004

(54) Pamela horses equine & accessories

(76) Inventor: Pamela Rudenia Caldwell, Broken Bow, OK (US)

Correspondence Address: PAMELA PERRY, PO BOX 603, BROKEN BOW, OK, 74728, US

(21) Appl. No.: 10/007,478

(22) Filed: Apr. 26, 2002

(51) Int. Cl. A01N 1/00

(52) U.S. Cl. 428/16

(57) ABSTRACT

A rich man's toy made up mostly of recycled materials combined with a wood, metal, or pvc pipe skeleton, electrical wire for frame, electrical fence wire for shell, telephone cord for webbing, paper material for filler, and fabric for hide, 4-ply yarn for mane, tail, embroidring eyes, mouth, nostrils, and paint for hooves, rockers can be added but are optional as an accessary to create a finished product called the PAMELA EQUINE.

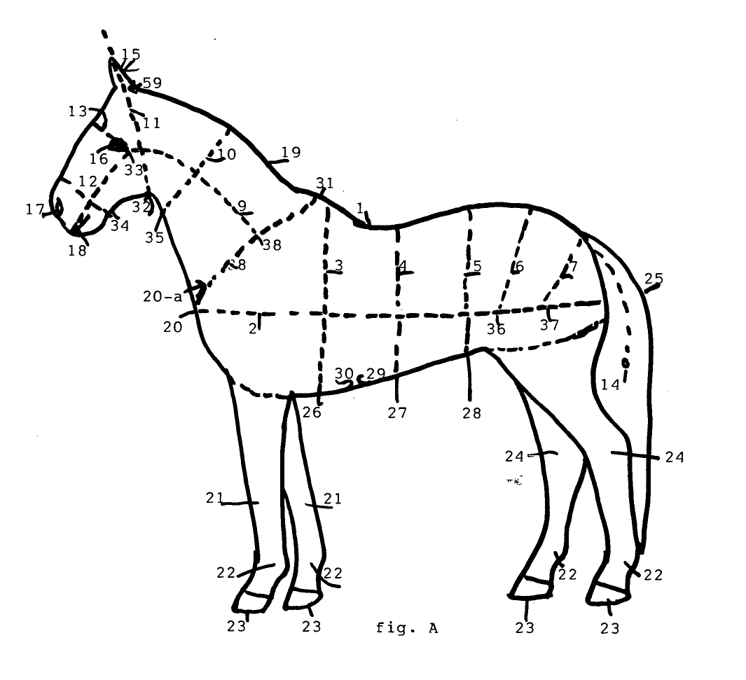

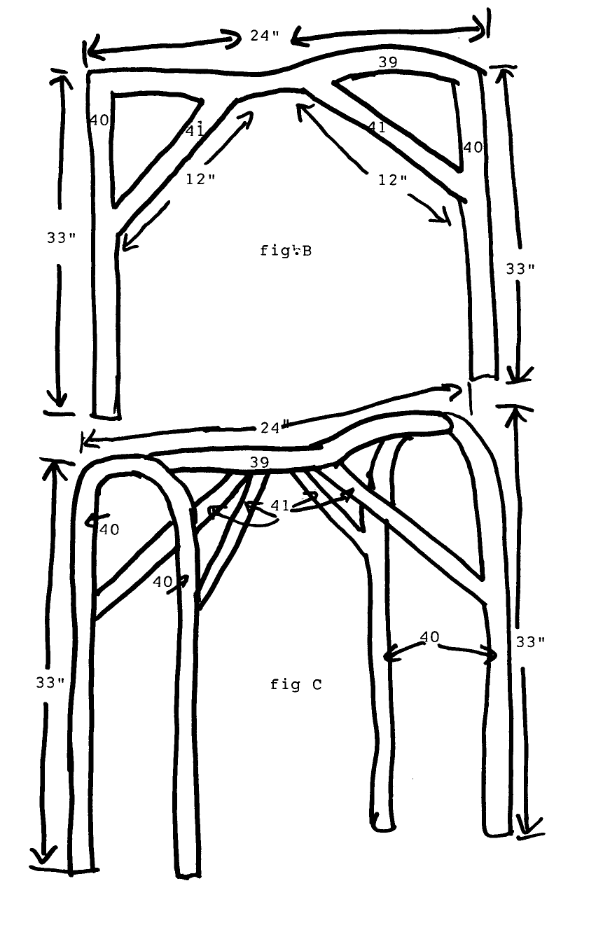

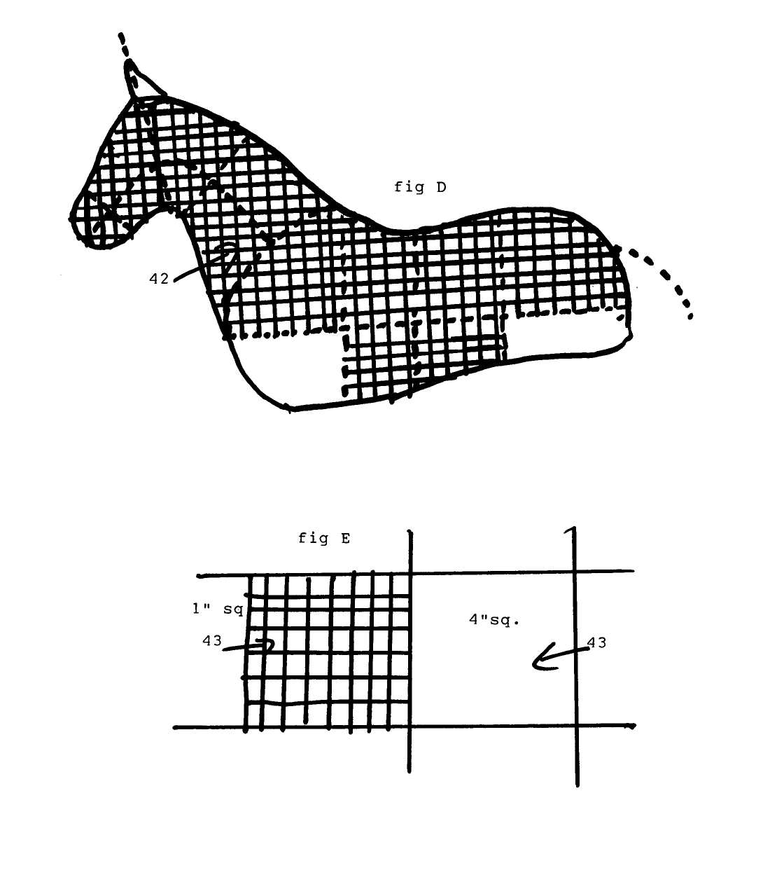

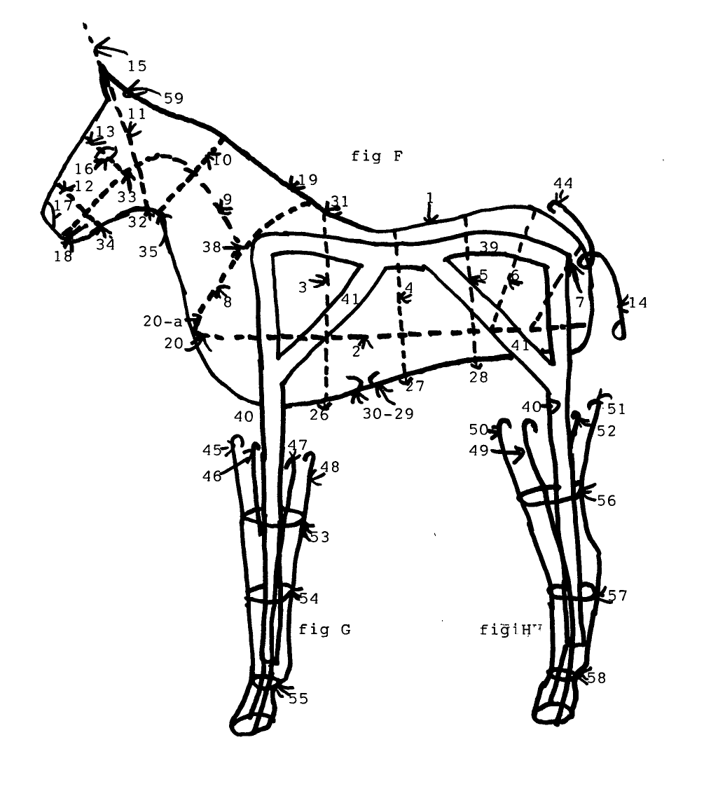

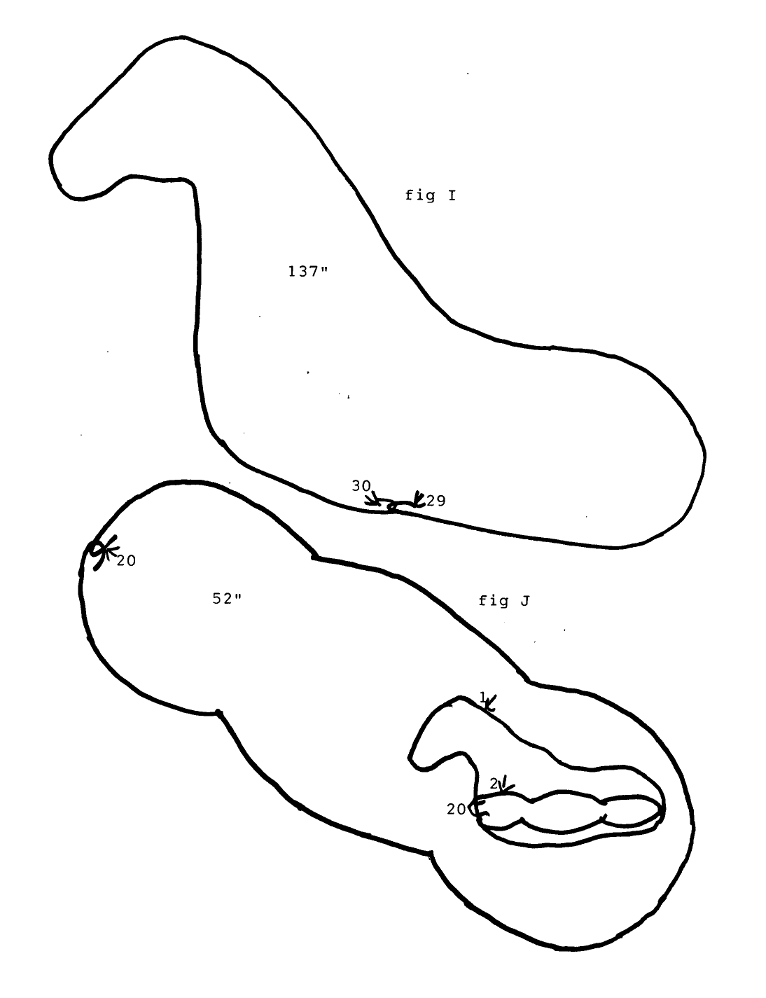

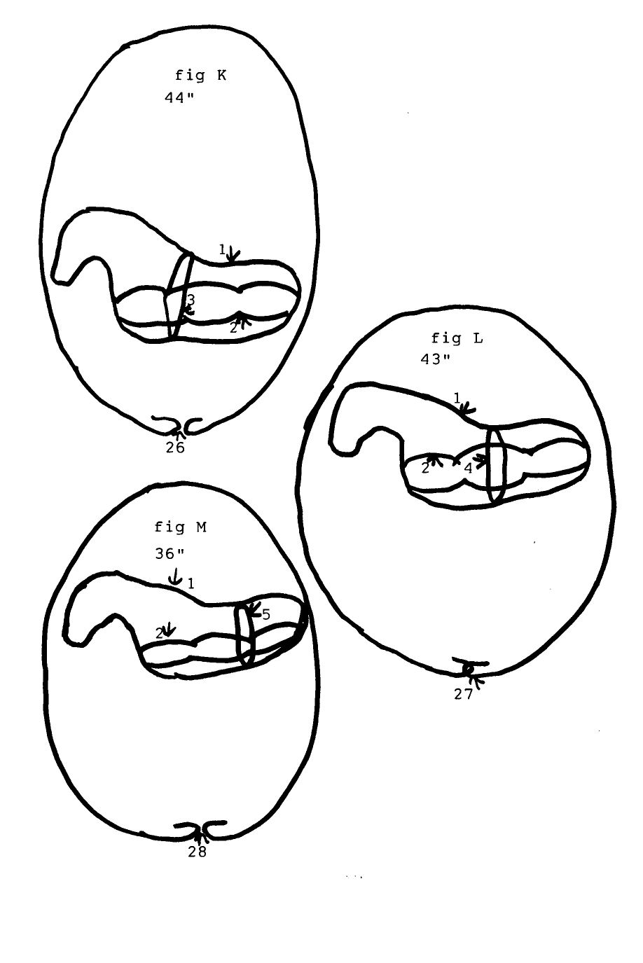

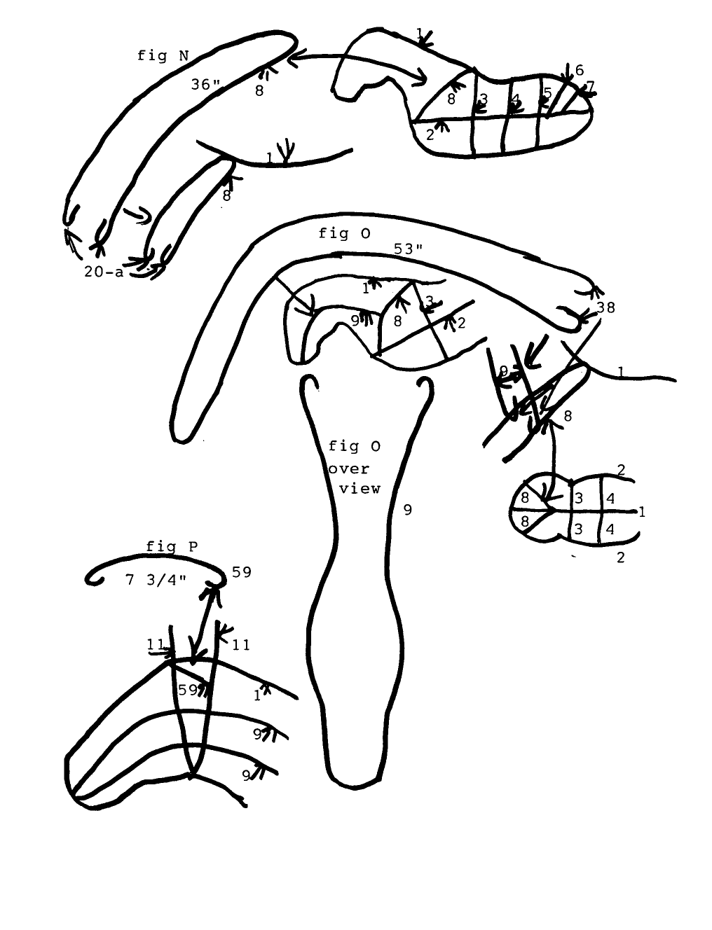

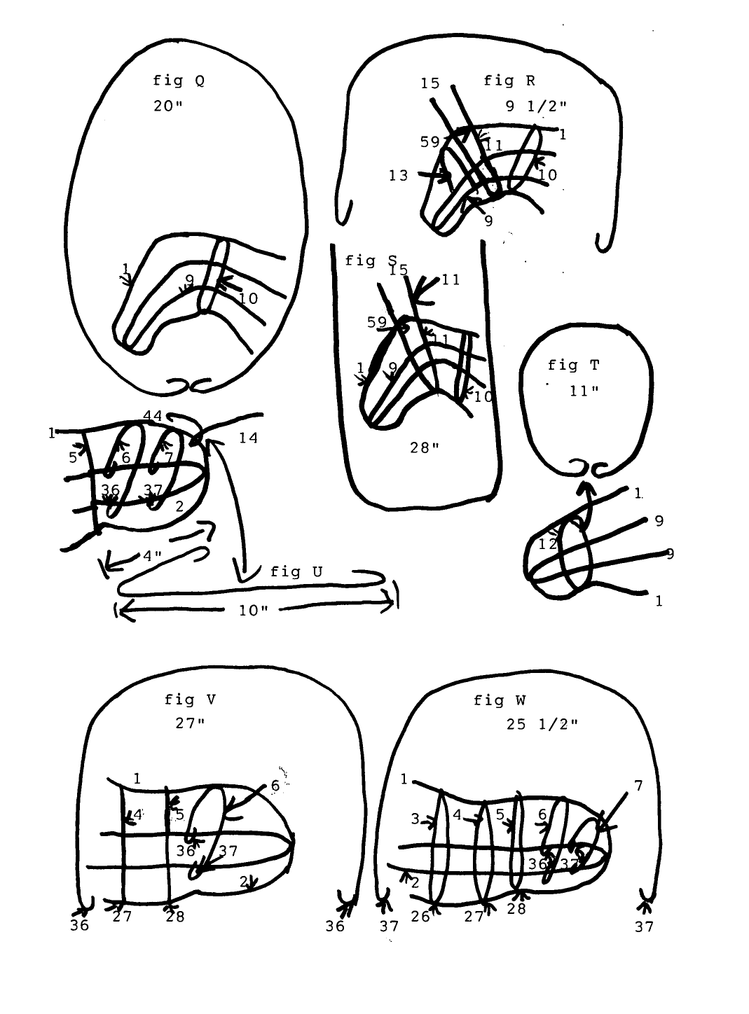

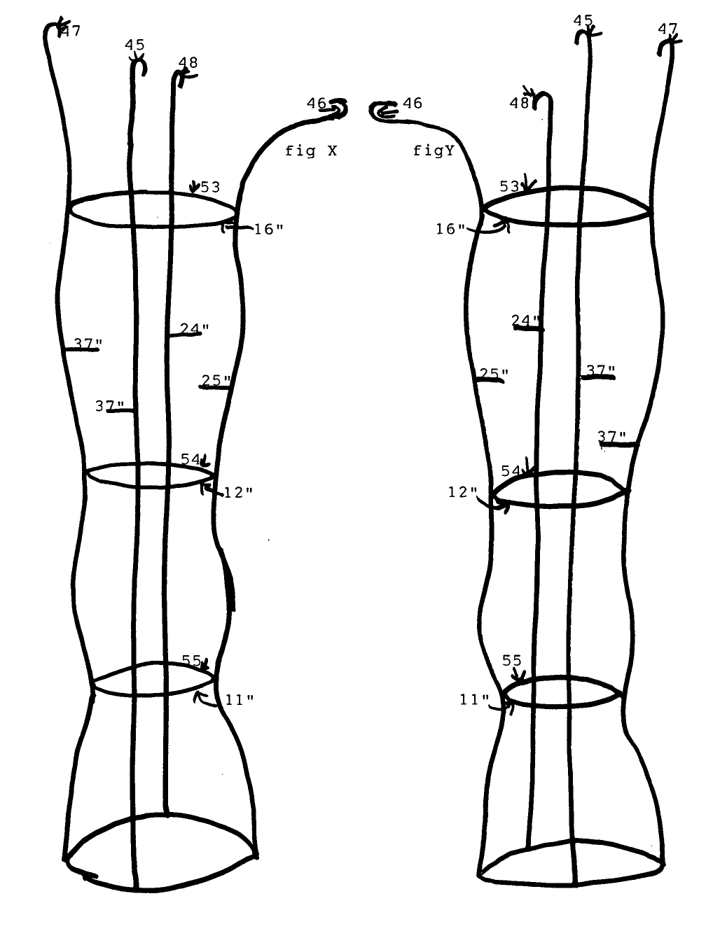

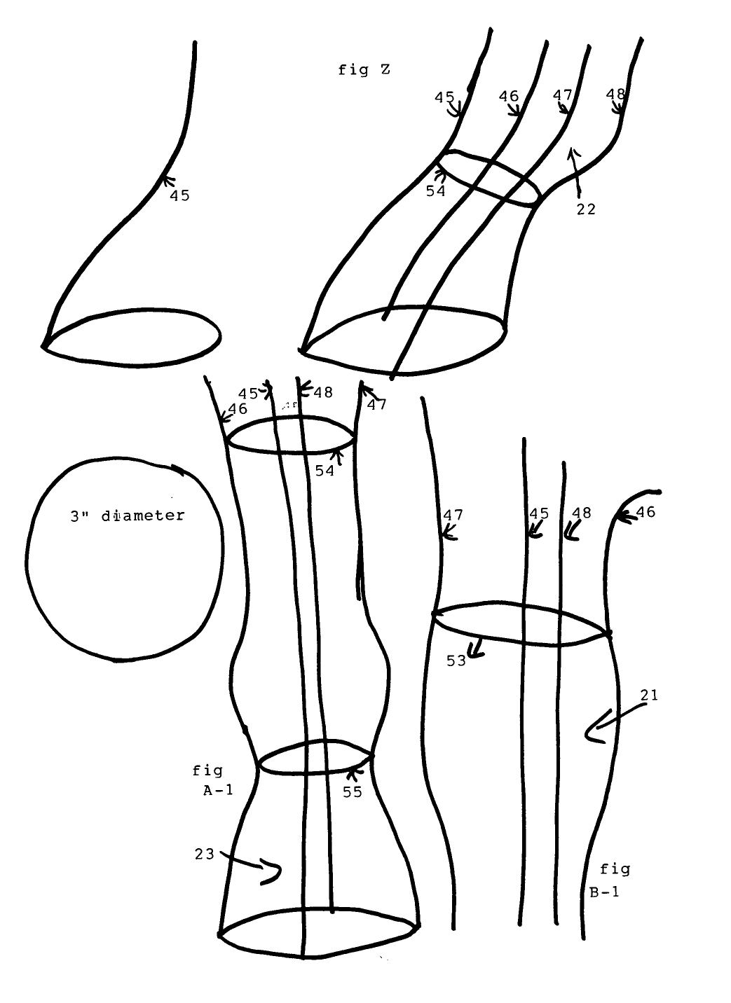

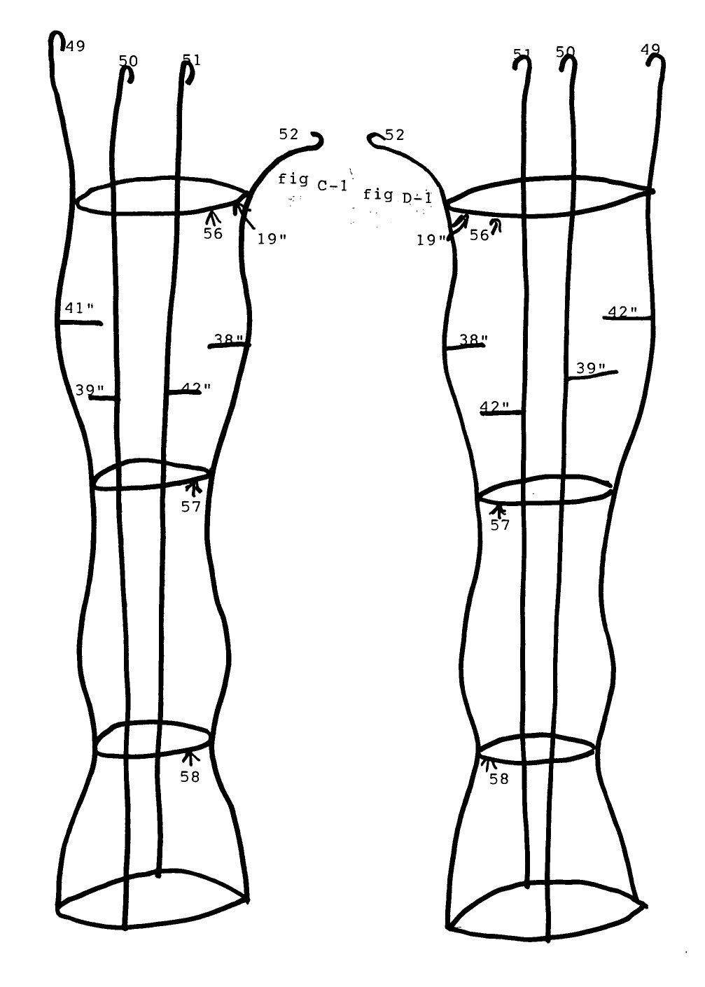

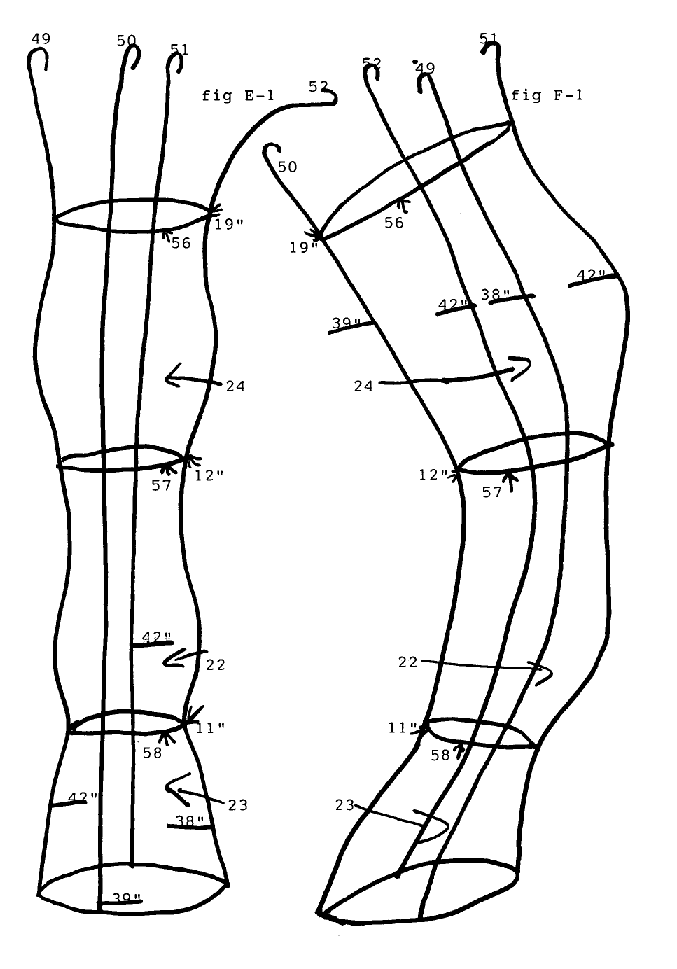

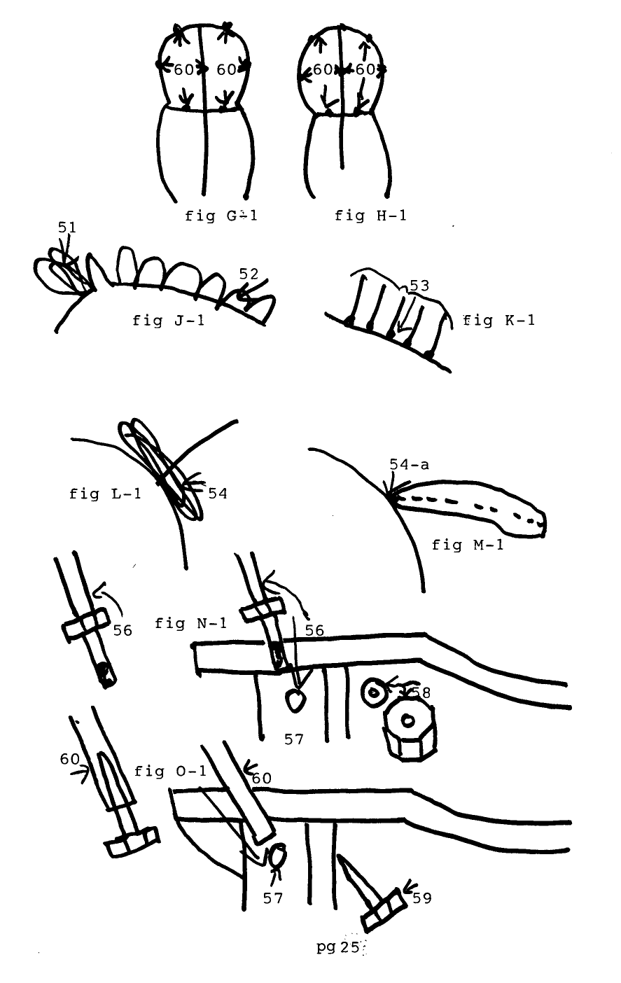

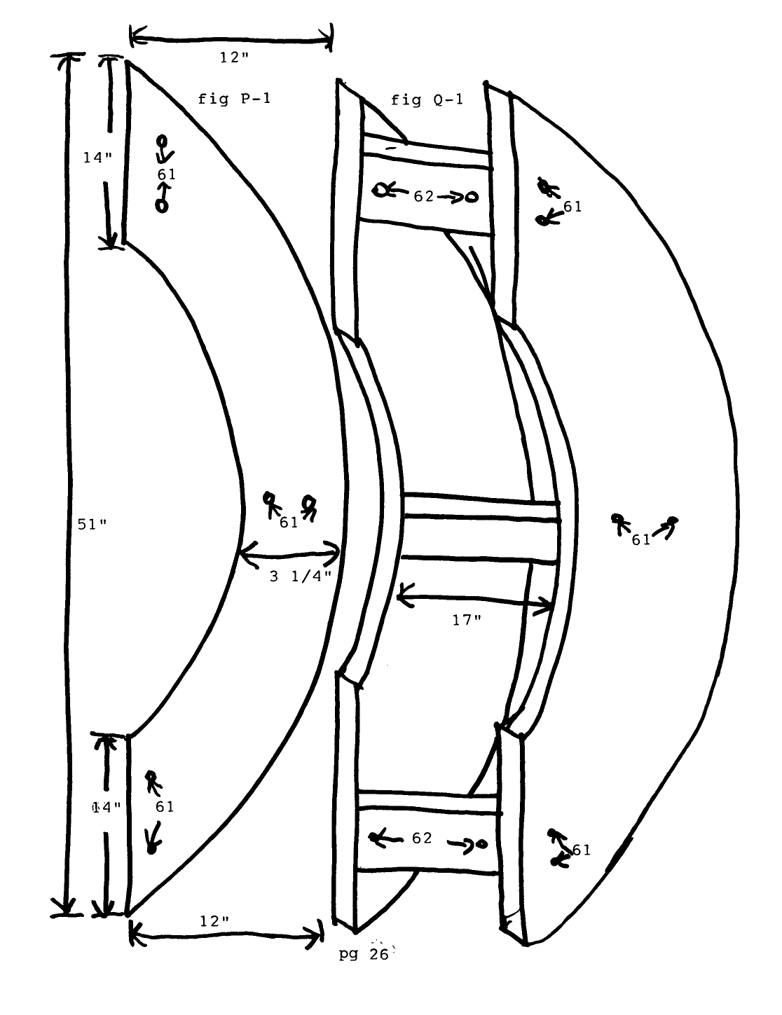

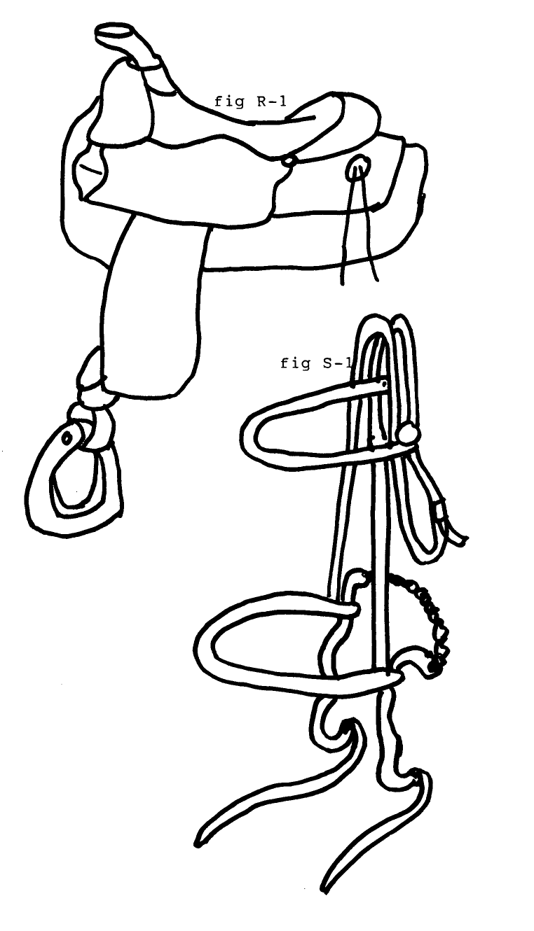

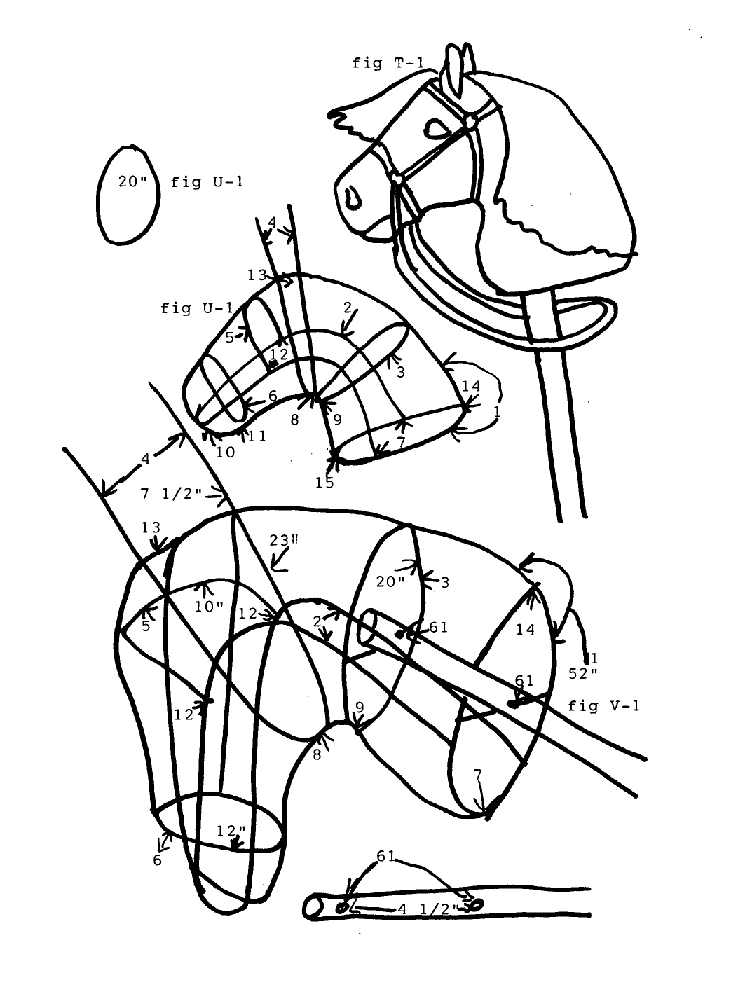

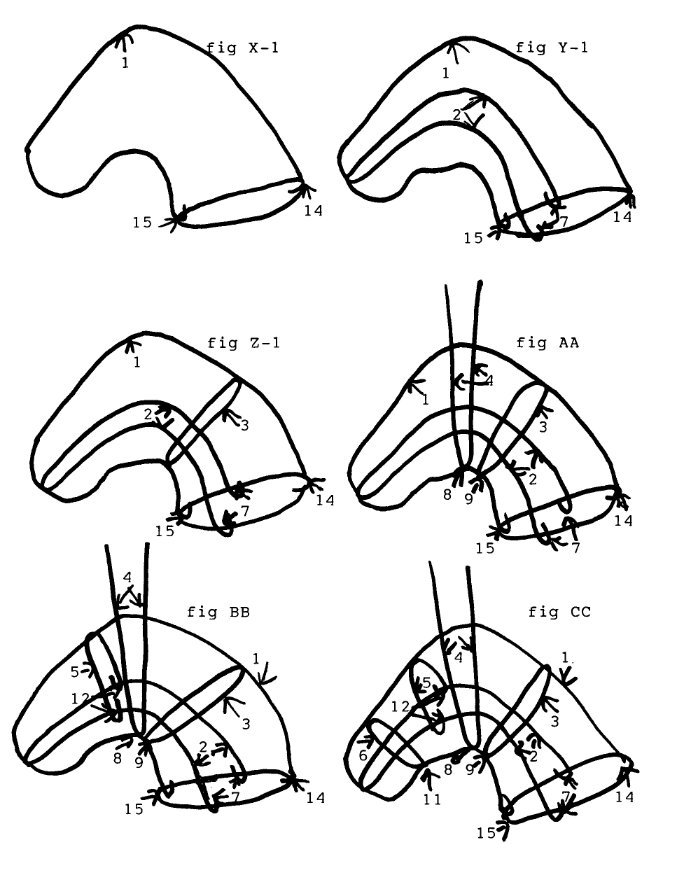

### FIELD OF INVENTION

The Pamela Horse is a rich man's toy which started out as something I started by taking sketches and drawings I made of live horses grazing in fields.

### BACKGROUND OF INVENTION

The Pamela Horse is a rich man's toy which started out as something I started by taking sketches and drawings I made of live horses grazeing in fields by taking pieces of wire and shapeing it into a decorative piece that is made up of recycled wire, paper, pvc pipe, rebar, dowel sticks, the only new items would be the cloth and yarn, then shapeing it to the pictures piece by piece.

### SUMMARY OF INVENTION

A rich man's toy made up mostly of recycled materials combined with a wooden, metal, pvc pipe skeleton, electrical wire for frame, electrical fence wire for shell, telephone, cord for webbing, paper or other suitable material for filler, and fabric for hide, 4-ply yarn for mane, tail, embroidring eyes, mouth, nostrils, rockers can be added but are optional as an accessary to create a finished product called the PAMELA EQUINE.

### BRIEF DESCRIPTION OF DRAWINGS

The general idea of this invention is to have a horse though not a real one for people who do not have the space or the money to keep a live animal, and can be used to create a theme in a western look.

### DETAIL DESCRIPTION OF DRAWINGS

10 AW ELECTRICAL WIRE (FOR BODY AND LEGS) OR ANY SUITABLE TYPE

ELECTRIC FENCE WIRE (CONNECTING WIRE) OR ANY SUITABLE TYPE

SIX CONDUCTOR WIRE (TELEPHONE CORD) OR ANY FINE WIRE

STUFFING MATERIAL (PACKING PEANUTS, PAPER, ANY SUITABLE FILLER)

FABRIC 3½ YARDS (VALOUR WORKS BEST BUT IS OPTIONAL)

YARN 5 SKIENS 4-PLY (FOR MANE, TAIL, EYES, AND MUZZLE)

REBAR ¾ IN.FOR BACK & LEGS AND ½ IN.FOR BRACES (ANY SUITABLE)

(OR) MOP HANDLES OR DOWL STICKS 1″ IN DIAMETER

2×6 BOARD FOR ROCKERS

2×4 CAN BE USED FOR BACK WITH MOP HANDLES OR DOWL STICKS (5/16 BOLTS (HEX) TO SECURE HORSE TO ROCKERS 4 (OR (3 INCH LAG SCREWS (TO USE WITH WOODEN FRAME)

### For “JIM DANDY”

DOWL STICK (1 IN.IN DIAMETER OR MOP HANDLES THE SAME SIZE 10 AW ELECTRICAL WIRE (FOR HEAD) OR ANY SUITABLE TYPE OF WIRE ELECTRIC FENCE WIRE (CONNECTING WIRE)ANY SUITABLE TYPE STUFFING MATERIAL (PACKING PEANUTS, PAPER, ANY SUITABLE FILLER TOOLS NEEDED (SCISSORS, LARGE NEEDLE, THREAD, PINS, PLIERS, WIRE-CUTTERS, SKILLSAW, RACHET W/SOCKETS; ½ IN.DRIVE, ⅜ WOOD BIT, ⅛ DRILL BIT, TAPE MEASURE, WOOD SCREWS, DRILL

### Specification

This pattern will produce a horse 39 ½″ long and 54″ tall to be used as a decorative item for a western theme. This also has a brief description of the several views of the drawings.

### Frame

Begin by measuring 10 aw electric wire the length indicated and connecting together with hooked ends 29&30 to create top-line, then shape as indicated.

Take measured piece of 10 aw wire for body 2 and fold in half.twist onto topline at rear area and attach onto chest area 20 (hooked ends) of topline, shape body.

Measure wire for pieces 3-5 and fold in half and twist onto topline 1 where indicated on placement sheet on page 10, fold in half again and twist onto side pieces to connect body 2 and topline 1 together to create start of ribcage 3-5 connect with hooked ends 26-28 at grith and belly area and flank.

To make shoulders 8, fold measured piece in half and twist onto topline 1 in front of withers 31 and connect onto body 2 at chest 20-a.

To do jowls & neck 9 measure wire and fold in half and twist onto muzzle tip 18 where upper lip will be, then connect to shoulders 8 with hooked ends 38.

To do throat 10 fold wire in half and twist onto crest of neck 19 where indicated, fold in half agian and twist around neck and cheek 9 and connect to base of throat 35 with hooked ends 35.

Add jowl and ears 11,15 by taking measured piece, fold in half and twist on at throat 32 area of head and attach poll piece 59 at base of ears with hooked ends.

Fold forehead 13 piece in half, twist onto topline 1 wire of head where indicated, shape and attach to cheek with hooked ends 33.

Take wire for muzzle 12 and fold in half, twist onto bridge of nose where indicated twist around cheek 9 piece and attach to chin area with hooked ends 34.

Take measured piece for point of hips 6, fold in half, twist onto topline 1 where indicated, attach to body 2 section with hooked ends 36 and repeat steps with croup 7 and hooked end 37.

Attach tail 14 to body by measuring about four inches and fold, twist onto topline 1 just below croup 7, then attach to point of hip 6 with hooked end 44.

### Shell

Use connecting wire (electrical fencing wire) at 4″ intervals this should produce sqaures 43 on page 12, to make shell 42 be sure to do whole body to secure and form muscle and tone.

### Webbing

To make webbing 43-a use six conductor wire (telephone cord) stripped of outer covering, tie onto shell 42 anywhere to start and twist around both connecting wire 43 and body pieces at 1″ intervals all over body until you have 1″ sqaures covering body area completely, do the same with the legs fig.G&H on page 13. Before attaching to body.

### Fore and Hind Legs

Start with front of leg and sole of hoof 45 and shape as indicated, then measure and attach 46-48 at center points, shape hoof and ankle 22 & 23 with connecting wire create pastern 55, cannon 54, and forearm 53 as shown on placement sheet for legs page 13, repeat process for hind legs page 20-21 and attach to body where indicated by dots 60 on page 22, stuff whole body tightly and completely with filler material, twist paper around wire for ears 15, then bend excess down to hold paper in place.

### Hide

Take cloth and stretch it over completed and stuffed body and pin it in place to mold it to all body parts while cutting off excess, then stitch all parts with a hidden stitch.

### Mane

Take yarn and seperate it so you have two halves, use a heavy needle with a big eye to stitch in fore-lock 51, and all along the crest of the neck 52 to desired length, tie a knot 53 in yarn as close as possible to cloth to secure so it won't pull out.

### Tail

Take a small strip of material and stitch on at base of tail 54-a then along wire and then repeat process with the needle and yarn to desired length or twist tail wire around a thick bundle of yarn doubled to desired length 54.

### Nostrils, Eyes, and Mouth

Take a marker and outline areas for these items 16,17,18 then embriodry areasto complete horse, paint on hooves.

### Rockers/Optional

To add rockers to horse on rebar (or alternative metal) skeleton frame weld head of 16-18 hex bolt 56 to ends of legs to attach to rocker braces 57 with a nut and washer 58.

Use a ⅛ drill bit for holes to put rocker together and a ⅜ wood bit to drill holes through braces 57 (on page 22 (for ⅛ drill bit for rocker look on page 23 number 61) to attach horse to rockers.

To add rockers to horse on a wooden skeleton frame, drill holes in the ends of legs 60 with a ¼ drill bit appropiate for a 3″ lag screw 59 ¼″ in diameter and a ⅜ wood bit to drill holes 57 on page 22 through braces 62 on page 23 to attach to horse.

For the stick horse “JIM DANDY” cut electrical wire according to the measurements on the diagram on page 28, then use the directions for the head and neck parts of the PAMELA HORSE to complete.

1. The Pamela Horse is a decorative piece that is made up of recycled wire, paper, rebar, pvc pipe to build the frame, dowl sticks, cloth, yarn, and paint. I Pamela Rudenia Caldwell claim that the equine made in this form is strictly and soley a PC invention, the rockers are strictly optional.
